(19) United States
(12) Patent Application Publication
(10) Pub. No.: US 2008/0058460 A1
(43) Pub. Date: Mar. 6, 2008

(54) Silicone hot melt additive for thermoplastics

(75) Inventors: Lauren Marie Tonge, Sanford, MI (US); James Steven Tonge, Sanford, MI (US)

Correspondence Address: DINSMORE & SHOHL LLP, ONE DAYTON CENTRE, ONE SOUTH MAIN STREET, SUITE 1300, DAYTON, OH, 45402-2023, US

(73) Assignee: Dow Corning Corporation, Midland, MI (US)

(21) Appl. No.: 11/516,010

(22) Filed: Sep. 5, 2006

(51) Int. Cl. C08F 8/00

(52) U.S. Cl. 524/494; 525/100

(57) ABSTRACT

A thermoplastic composition. The thermoplastic composition includes a thermoplastic; a silicone hot melt additive; and optional filler. A method of processing the thermoplastic composition is also disclosed.

### BACKGROUND OF THE INVENTION

The present invention relates generally to thermoplastic compositions, and more particularly to thermoplastic compositions including a silicone hot melt additive.

Silicone additives are highly effective internal and external lubricants in plastics. Silicone oils and gums also improve surface properties of the resultant plastic such as scratch and abrasion resistance while reducing friction. Incorporation of liquid silicone additive requires special processing equipment, and these lower molecular weight silicones can also migrate, bloom or bleed out of the materials at higher concentrations. Some producers, such as Dow Corning, DuPont, Micropol, and Wacker, suggest free flowing powders or masterbatches in different plastics, thermoplastics and thermoplastic elastomers as a way to overcome the difficult incorporation of these silicone additives. Inefficient mixing can occur if the melt flow index of the masterbatch is lower than the base polymer.

Filled thermoplastics can be especially difficult to process. The addition of fillers to thermoplastics affects the desired physical properties and causes the viscosity of the composition when it is melted to increase. The increased viscosity of the melt reduces the production rate during extrusion or other melt processing. This increase in melt viscosity can be partially compensated for by raising the melt temperature during processing. However, increasing the melt temperature increases the risk of degradation of the thermoplastic.

WO 2005/073984 describes a filled perfluoropolymer system. The composition includes a perfluoropolymer, an inorganic filler, and a small amount of a hydrocarbon polymer. The hydrocarbon polymer is thermally stable at the melting temperature of the perfluoropolymer. The hydrocarbon polymer is said to act as a dispersing agent for the filler giving a uniform-appearing melt blend and limiting the reduction in tensile properties that the filler would have on the thermoplastic composition if used by itself.

However, there remains a need for improved filled thermoplastic compositions and for a method of processing the filled thermoplastic compositions.

### SUMMARY OF THE INVENTION

The present invention meets this need by providing a thermoplastic composition. The thermoplastic composition includes a thermoplastic and a silicone hot melt additive. The thermoplastic composition may contain an optional filler.

Another aspect of the invention is a method of processing a thermoplastic composition. The method includes extruding a thermoplastic composition, the thermoplastic composition comprising: a thermoplastic, a silicone hot melt additive and an optional filler.

### DETAILED DESCRIPTION OF THE INVENTION

The thermoplastics used in the compositions are those that are sufficiently flowable when melted that they can be melt processed, such as extruded, to make products that are strong enough to be useful.

Thermoplastics and thermoplastic materials can be based upon a variety of chemical systems. Examples include but are not limited to, polyethylenes, polypropylenes, polystyrenes, polyesters, polycarbonates, nylons, acrylics and polyacrylates, such as poly(methyl methacrylates); butyl, polybutene and polyisobutylene; polymers such as liquid crystal polymer (LCP) and polyolefins; ethylene copolymers such as polyethylene acrylate acid (EAA); and vinyl and polyvinyl chloride (PVC). Common thermoplastic and thermoplastic materials include ionomers, ketones such as polyetheretherketone (PEEK), polyamides and polycarbonates, polyester and polyether block amide (PBA), and polyphenylene oxide (PPO) and polyphenylene sulphide (PPS). Styrene-isoprene-styrene (SIS) and styrene-butadiene-styrene (SBS) copolymers are used in pressure sensitive adhesive (PSA) applications. Styrene butadiene rubber (SBR) has good resistance to petroleum hydrocarbons and fuels. Styrene acrylonitrile copolymers include styrene acrylonitrile (SAN), acrylic styrene acrylonitrile (ASA) and acrylonitrile ethylene styrene (AES). The term thermoplastics includes those materials covered by the terminology described in ASTM Designation: D5538-02 Standard Practice for Thermoplastic Elastomers-Terminology and Abbreviations.

The composition may optionally contain fillers typically used in thermoplastic or thermoplastic materials. The filler level will be determined by the final application property and cost requirements. Any type of filler or blend of fillers typically used in thermoplastic, thermoplastic materials, or their blends can be used. Suitable fillers include, but are not limited to: extending fillers such as quartz, calcium carbonate, and diatomaceous earth; pigments, such as iron oxide and titanium oxide; fillers, such as silica, carbon black and finely divided metals; heat stabilizers, such as hydrated cerric oxide, calcium hydroxide, magnesium oxide; flame retardants, such as zinc oxide, halogenated hydrocarbons, alumina trihydrate, magnesium hydroxide, wollastonite, organophosphorous compounds and other fire retardant (FR) materials; and other additives known in the art, such as glass fibers, stainless steel, bronze, graphite fiber, graphite, molybdenum disulphide, bronze, thermally conductive fillers, ceramics, polyphenylene sulfones, barium sulphate, magnesium chloride, clays and micas, wood, natural fibers, nanoclays.

The composition includes a silicone hot melt additive. As used herein, the phrase “silicone hot melt additive” means a silicone-containing material which is solid at room temperature (about 25° C.) or the end-use temperature of the final plastic product, whichever is higher, but which melts to form a liquid at temperatures above this. When both the silicone hot melt additive and the thermoplastic are molten, they are generally not miscible and, thus, the silicone tends to migrate to a surface of, for example, the barrel of the extruder or the surface of a filler, if present.

The transition temperature at which the silicone hot melt additive converts from a solid to a liquid should be lower than or at the temperature at which the thermoplastic composition is processed. As such, its melt transition temperature or a softening temperature is above about 25° C., alternatively in the range of about 50 to about 200° C., or alternatively in the range of about 70 to about 150° C.

The silicone hot melt additive is generally present in an amount of less than about 10 wt %, alternatively less than about 5 wt %, alternatively about 0.1 to about 3 wt %, and alternatively about 1 to about 3 wt. %. The optimum level of silicone hot melt additive is system dependant and can be determined by further experimentation by one skilled in the art.

The silicone hot melt additive by its inherent nature generally does not require additional processing or masterbatching to be incorporated effectively into plastic, thermoplastic and thermoplastic elastomers and will generally not migrate at room temperature since it is a solid silicone-containing material at end use temperatures.

The transition temperature of the silicone hot melt additive depends on its composition. Suitable silicone hot melt additives include, but are not limited to silicone thermoplastics, silicone elastoplastics, silicone solventless adhesives, silicone pressure sensitive adhesives, silicone film adhesives, silicone-resins, silicone-resin/silicone-polymer blends, and silicone copolymers, which all have their melt transition temperature or a softening temperature above about 25° C. Silicone resin polymer blends include, but are not limited to, silicone resins of the MQ-type and silicone gums. These resin polymer blends are described in U.S. Pat. No. 5,708,098, which is incorporated herein by reference. Suitable silicone copolymers include, but are not limited to, copolymers containing only silicone groups and silicone organic copolymers. Suitable silicone organic copolymers include, but are not limited to: silicone amines, such as silicone urethanes, silicone ureas, silicone etherimides, and silicone imides; silicone olefins; silicone polyesters, such as silicone epoxies, silicone acrylics, and silicone methacrylics; silicone aryls, such as silicone styrenes, and silicone biphenylsulphones; and silicone polyethers. Typically, a silicone hot melt additive is selected such that it has an appropriate melt transition temperature for the circumstances and appropriate physical and chemical properties for use in the resultant thermoplastic composition. For example, one can increase or decrease discoloration by selecting more thermally stable materials such as phenyl silicone containing hot melt additives instead of amine containing silicone hot melt additives which are less thermally stable.

The processing temperature for a thermoplastic composition of the invention is determined by the specific thermoplastic, thermoplastic material, or blend melt temperatures. The melt temperature is the initial temperature where the thermoplastic start to deform. The process temperature is typically higher than the melt temperature by about 30-50° C. or more to get good flowability.

When fillers are incorporated in thermoplastic compositions, there is often shear heating during processing which drives the temperatures of the compositions higher. The silicone hot melt additives of the invention can often change the final exit temperatures of such materials. The silicone hot melt additives are believed to compatibilize the filler surface and to migrate to the mixer/extruder surface and lubricate. Silicone hot melt additives behave similarly to traditional silicone additives used in this application. The ability to process the thermoplastic composition at lower temperatures helps to prevent degradation of the thermoplastic.

It should also be noted that without the silicone hot melt additive, the melt blend of a filled thermoplastic may not be uniform; it can have cracks, or unincorporated filler. However, when the silicone hot melt additive is included, the melt blend appears uniform.

Although not wishing to be bound by theory, it is believed that the presence of a small amount of a silicone hot melt additive in the filled thermoplastic can modify the filler surface in a non-reactive way to treat the surface of the filler in-situ. The silicone hot melt additive is also believed to migrate to the thermoplastic surface during processing to produce a better extrudate.

The thermoplastic composition can include other additives or mixtures of additives of the types and in the amounts typically used in processing thermoplastic compositions. Such additives, include, but are not limited to, compatibilizers, functionalizers, impact modifiers, plasticizers, antioxidants, processing aids, other lubricants, or ultraviolet light stabilizers.

The thermoplastic composition can be melt blended and made into pellets. The pellets can then be used as the feed for an extruder or other melt processing equipment.

### EXAMPLES

The following examples are presented to further illustrate the compositions and method of this invention, but are not construed as limiting the invention, which is delineated in the appended claims. All parts and percentages in the examples are on a weight basis and all measurements were obtained at approximately 23° C., unless otherwise indicated.

IP-60 is a polyethylene resin and is marketed by the Dow Chemical Company, Dow Plastics as DOWLEX™ IP-60.

Additive 1 is a silicone hot melt additive with of 74 weight percent MQ type resin containing methyl and alkenyl groups and 26 weight percent of a polydimethylsiloxane gum containing terminal and pendant vinyl groups with a total of 650 ppm vinyl and a plasticity of about 150 mm/100.

Additive 2 is a silicone hot melt additive with of 71 weight percent MQ type resin containing methyl and alkenyl groups and 29 weight percent of a polydimethylsiloxane gum containing terminal and pendant vinyl groups with a total of 7500 ppm vinyl and a plasticity of about 150 mm/100.

Additive 3 is a silicone hot melt additive with 48 weight percent 900 DP polydimethyl siloxane soft segments and 52 weight percent vinyl capped phenyl-T resin hard segments.

Talc is hydrous magnesium silicate (CAS# 14807-96-6) marketed by Sigma-Aldrich Co. as Talc, powder, <10 micron powder.

### Example 1

Sample 1A: IP-60 (285 g) was added manually to a 379 ml Haake mixer equipped with banbury-rollers at 200° C. over 5 minutes at low rpm's (revolutions per minute). The rpm's were increased to 120 rpm over 2 minutes. The material was mixed at 120 rpm for 5 minutes.

Sample 1B: IP-60 (285 g) and Additive 3 (2.85 g) were added to a 379 ml Haake mixer equipped with banbury-rollers and processed the same as Sample 1A.

Sample 1B had a whiter shinier appearance than Sample 1A after processing

### Example 2

Sample 2A: IP-60 (142 g) and Talc (142) were added manually to a 379 ml Haake mixer equipped with banbury-rollers at 200° C. over 5 minutes at low rpm's (revolutions per minute). The rpm's were increased to 120 rpm over 1 minutes. The material was mixed at 120 rpm for 5 minutes.

Sample 2B: IP-60 (142 g) and Talc (142) and Additive 2 (1.5) were added to a 379 ml Haake mixer equipped with banbury-rollers and processed the same as Sample 2A.

Sample 2C: IP-60 (142 g) and Talc (142) and Additive 3 (1.5) were added to a 379 ml Haake mixer equipped with banbury-rollers and processed the same as Sample 2A.

All three samples stuck to the mixer surfaces in varying degrees. Sample 2A was stickier than Sample 2B, which was stickier than sample 2C. Therefore, the cleaning ease was greatest for Sample 2C, followed by Sample 2B, and finally sample 2A. The sample color decreased from Sample 2A to Sample 2B to Sample 2C, which was the lightest.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

What is claimed is:

1. A thermoplastic composition comprising:
a thermoplastic;
a silicone hot melt additive; and
an optional filler.

2. The thermoplastic composition of claim 1 wherein the silicone hot melt additive is selected from silicone thermoplastics, silicone elastoplastics, silicone solventless adhesives, silicone pressure sensitive adhesives, silicone film adhesives, silicone-resins, silicone-resin/silicone-polymer blends, silicone copolymers, or combinations thereof.

3. The thermoplastic composition of claim 2 wherein the silicone hot melt additive is a silicone copolymer.

4. The thermoplastic composition of claim 3 wherein the silicone copolymer is a silicone organic copolymer.

5. The thermoplastic composition of claim 4 wherein the silicone organic copolymer is selected from silicone amines, silicon olefins, silicone polyesters, silicone aryls, silicone polyethers, or combinations thereof.

6. The thermoplastic composition of claim 4 wherein the silicone organic copolymer is a silicone amine selected from silicone urethanes, silicone ureas, silicone etherimides, silicone imides, or combinations thereof.

7. The thermoplastic composition of claim 4 wherein the silicone organic copolymer is a silicone polyester selected from silicone epoxies, silicone acrylics, silicone methacrylics, or combinations thereof.

8. The thermoplastic composition of claim 4 wherein the silicone organic copolymer is a silicone aryl selected from silicone styrenes, silicone biphenyl sulphones, or combinations thereof.

9. The thermoplastic composition of claim 1 wherein the silicone hot melt additive is a silicone resin polymer blend.

10. The thermoplastic composition of claim 9 wherein the silicone resin polymer blend is a silicone MQ-type resin and silicone gum.

11. The thermoplastic composition of claim 1 wherein the silicone hot melt additive has a melt transition temperature or a softening temperature above about 25° C.

12. The thermoplastic composition of claim 1 wherein the silicone hot melt additive has a melt transition temperature or a softening temperature in the range of about 50 to about 200° C.

13. The thermoplastic composition of claim 1 wherein the silicone hot melt additive has a melt transition temperature or a softening temperature in the range of about 70 to about 150° C.

14. The thermoplastic composition of claim 1 wherein the silicone hot melt additive is present in an amount of up to about 10 wt %.

15. The thermoplastic composition of claim 1 wherein the silicone hot melt additive is present in an amount of about 0.1 to about 3 wt %.

16. The thermoplastic composition of claim 1 wherein the filler is selected from extending fillers, pigments, reinforcing fillers, heat stabilizers, flame retardants, thermally conductive fillers, glass fibers, stainless steel, bronze, graphite fiber, graphite, molybdenum disulphide, bronze, ceramics, polyphenylene sulfones, barium sulphate, magnesium chloride, clays, micas, wood, natural fibers, nanoclays, or combinations thereof.

17. The thermoplastic composition of claim 1 wherein the thermoplastic is selected from polyolefins, polystyrenes, polyesters, polycarbonates, nylons, acrylics, polyacrylates, butyl, polybutenes, polyisobutylenes, liquid crystal polymers (LCP), ethylene copolymers, vinyl chloride, polyvinyl chloride (PVC), ionomers, ketones, polyamides, polyether block amide (PBA), polyphenylene oxide (PPO), polyphenylene sulphide (PPS), or combinations thereof.

18. A thermoplastic composition comprising:
a thermoplastic;
a silicone hot melt additive, wherein the silicone hot melt additive has a melt transition temperature or a softening temperature above about 25° C., and wherein the silicone hot melt additive is present in an amount of up to about 10 wt %; and
an optional filler.

19. A method of processing a thermoplastic composition comprising:
extruding a thermoplastic composition, the thermoplastic composition comprising:
a thermoplastic;
a silicone hot melt additive; and
an optional filler.

20. The method of claim 19 wherein the silicone hot melt additive has a melt transition temperature or a softening temperature above about 25° C., and wherein the silicone hot melt additive is present in an amount of up to about 10 wt %.
